(19) United States
(12) Patent Application Publication
(10) Pub. No.: US 2013/0186089 A1
(43) Pub. Date: Jul. 25, 2013

(54) CONTINUOUS FLOW STEAM GENERATOR HAVING AN INTEGRATED REHEATER

(71) Applicants: Jan Brückner, Uttenreuth (DE); Joachim Franke, Nurnberg (DE)

(72) Inventors: Jan Brückner, Uttenreuth (DE); Joachim Franke, Nurnberg (DE)

(21) Appl. No.: 13/877,525

(22) PCT Filed: Sep. 29, 2011
(86) PCT No.: PCT/EP11/66966

§ 371 Date: Apr. 3, 2013

(30) Foreign Application Priority Data
Oct. 4, 2010 (DE) 102010041903.6

(51) Int. Cl. F03G 6/00; F22B 29/06; F22G 7/00; F22B 1/00; F22B 1/06

(52) U.S. Cl. CPC F03G 6/005; F22B 1/006; F22B 1/06; F22G 7/00; F22B 29/06
USPC 60/641.11; 122/32; 122/406.4; 122/476; 60/641.15

(57) ABSTRACT

A continuous flow steam generator including a vessel with a heat transfer medium inlet and a heat transfer medium outlet is provided. A heat transfer medium channel is formed between the heat transfer medium inlet and the heat transfer medium outlet, and a heat transfer medium flows in the channel, having steam generator tubes disposed in the heat transfer medium channel, wherein a first portion of the steam generator tubes, and a second portion of the steam generator tubes is designed as a system of preheating and boiler tubes, and the first portion is disposed upstream of the second portion in the flow direction of the heat transfer medium. A steam generator device having a continuous flow steam generator and a water separation system is also provided along with a solar thermal power plant.

### CROSS REFERENCE TO RELATED APPLICATIONS

This application is the US National Stage of International Application No. PCT/EP2011/066966, filed Sep. 29, 2011 and claims the benefit thereof. The International Application claims the benefits of German application No. 10 2010 041903.6 DE filed Oct. 4, 2010. All of the applications are incorporated by reference herein in their entirety.

### FIELD OF INVENTION

The invention relates to a forced-flow steam generator, in particular for solar thermal power plants, with integrated intermediate superheater.

### BACKGROUND OF INVENTION

Solar thermal power plants constitute an alternative to conventional power generation. At present, solar thermal power plants are embodied, for example, with tower collectors and indirect evaporation, in which a heat transfer medium is heated by solar radiation and its energy is delivered in a downstream heat exchanger (steam generator) to the working medium of a water/steam circuit, the steam generated in the process being fed to a steam turbine. Alternatives to the solar tower concept are power plants having parabolic trough collectors or Fresnel collectors, in which the energy of the sun is not concentrated on a tower, but rather a heat transfer medium is heated in tubes which run concentrically to a caustic line.

The abovementioned steam generator is at present embodied in such a way that it consists of, for example, four components (preheater, evaporator, superheater and intermediate superheater). A disadvantage with this is that this type of design involves high costs for the steam generator components themselves and also for the requisite pipeline system.

### SUMMARY OF INVENTION

An object of the invention is to propose a cost-effective steam generator. It is also an object of the invention to propose a cost-effective steam generating arrangement and a solar thermal power plant at reduced costs.

According to the invention, this object is achieved by the apparatus as claimed in the claims and by the apparatuses in the claims Advantageous developments of the invention are defined in the respective dependent claims. In a continuous-flow steam generator comprising a vessel which has a heat transfer medium inlet and a heat transfer medium outlet, wherein a heat transfer medium passage in which a heat transfer medium flows is formed between heat transfer medium inlet and heat transfer medium outlet, and comprising steam generator tubes arranged in the heat transfer medium passage, wherein a first part of the steam generator tubes is designed as a system of superheater tubes and intermediate superheater tubes and a second part of the steam generator tubes is designed as a system of preheating tubes and evaporator tubes, and the first part is arranged upstream of the second part in the direction of flow of the heat transfer medium, the entire steam generation (including reheating) takes place in one component, this reducing costs significantly. In the hitherto known embodiments of the steam generator, at least two pressure vessels (preheater+evaporator+superheater and separate intermediate superheater), usually even four pressure vessels, were necessary.

The superheater tubes and intermediate superheater tubes are advantageously connected up on a heat transfer medium side to form a heating surface. An extremely compact design of the continuous-flow steam generator is thus achieved.

The vessel of the steam generator is expediently a pressure vessel.

Furthermore, it is expedient if the pressure vessel is designed in such a way that a heat transfer medium flows through the pressure vessel from top to bottom.

The heat transfer medium is advantageously molten salt, since salts are nontoxic, are cost-effective and can be stored unpressurized in the molten state.

In an advantageous embodiment, the superheater tubes and the intermediate superheater tubes are arranged alternately side by side in the vessel in the direction of flow of a heat transfer medium.

In an alternative embodiment, the superheater tubes and the intermediate superheater tubes are arranged alternately one behind the other in the vessel.

The steam generating arrangement according to the invention also advantageously comprises, in addition to the continuous-flow steam generator according to the invention, a water separation system, wherein the first part of the steam generator tubes is connected downstream of the water separation system on the flow medium side.

In this case, the second part of the steam generator tubes is expediently connected upstream of the water separation system on the flow medium side.

Furthermore, it is expedient if superheater tubes adjoining evaporator tubes in parallel are connected directly downstream of the water separation system on the flow side.

In this case, according to an especially advantageous configuration, the steam generating arrangement with the steam generator is integrated into a solar tower power plant having indirect evaporation.

In an alternative configuration, the steam generating arrangement with the steam generator is integrated into a solar thermal power plant comprising parabolic trough collectors.

In a further alternative configuration, the steam generating arrangement with the steam generator is integrated into a solar thermal power plant comprising Fresnel collectors.

### BRIEF DESCRIPTION OF THE DRAWINGS

The invention is explained in more detail by way of example with reference to the drawings, in which, schematically and not to scale:

FIG. 1 shows a solar tower power plant with indirect evaporation, and

FIG. 2 shows a steam generating arrangement having a forced-flow steam generator with integrated intermediate superheater according to the invention and a water separator.

### DETAILED DESCRIPTION OF INVENTION

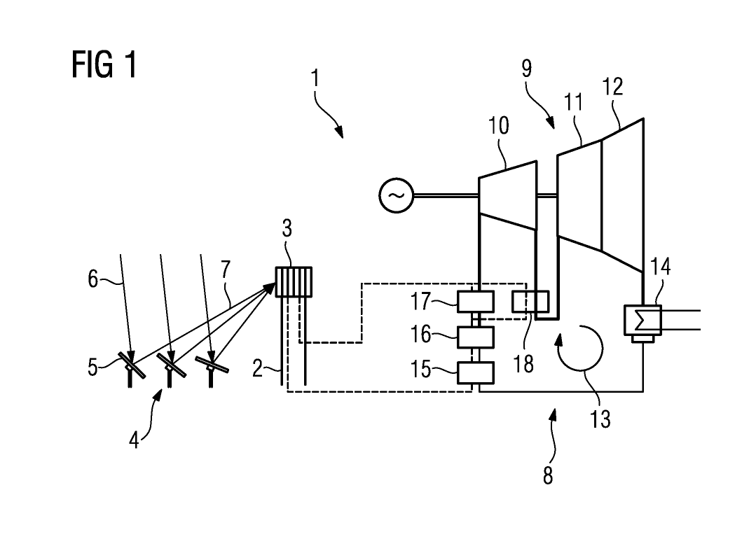

FIG. 1 schematically shows by way of example a solar tower power plant 1. It comprises a solar tower 2, on the vertically top end of which an absorber 3 is arranged. A heliostat field 4 with a number of heliostats 5 is arranged around the solar tower 2 at the base. The heliostat field 4 with the heliostats 5 is designed for focussing the direct solar radiation 6. In this case, the individual heliostats 5 are arranged and oriented in such a way that the direct solar radiation 6 from the sun is focussed in the form of concentrated solar radiation 7 on the absorber 3. In the solar tower power plant 1, the solar radiation is therefore concentrated on the tip of the solar tower 2 by a field of individual tracking mirrors—the heliostats 5. The absorber 3 converts the radiation into heat and delivers it to a heat transfer medium, for example molten salt or thermal oil, which supplies the heat to a conventional power plant process 8 having a steam turbine 9.

To transfer the heat to the working medium of the conventional power plant process 8, in which normally a steam turbine 9 having one or more pressure stages 10, 11, 12 is connected in a water/steam circuit 13, the feed water coming from the condenser 14 is directed through various heat exchangers 15, 16, 17. These heat exchangers 15, 16, 17 function as preheater 15, evaporator 16 and superheater 17. In addition, in order to increase the overall efficiency of the power plant, steam which is expanded in the high-pressure part 10 of the steam turbine 9 and is cooled down slightly, is normally reheated in a further heat exchanger 18 before entering the intermediate-pressure part 11. For the heat transfer from the heat transfer medium to the working medium, four components are therefore typically required. This type of design involves high costs for the steam generator components themselves and also for the requisite pipeline system. These problems are not just restricted to the type of solar thermal power plant shown in FIG. 1 but also concern other solar power plant types with indirect evaporation, such as, for example, power plants with parabolic troughs or Fresnel collectors.

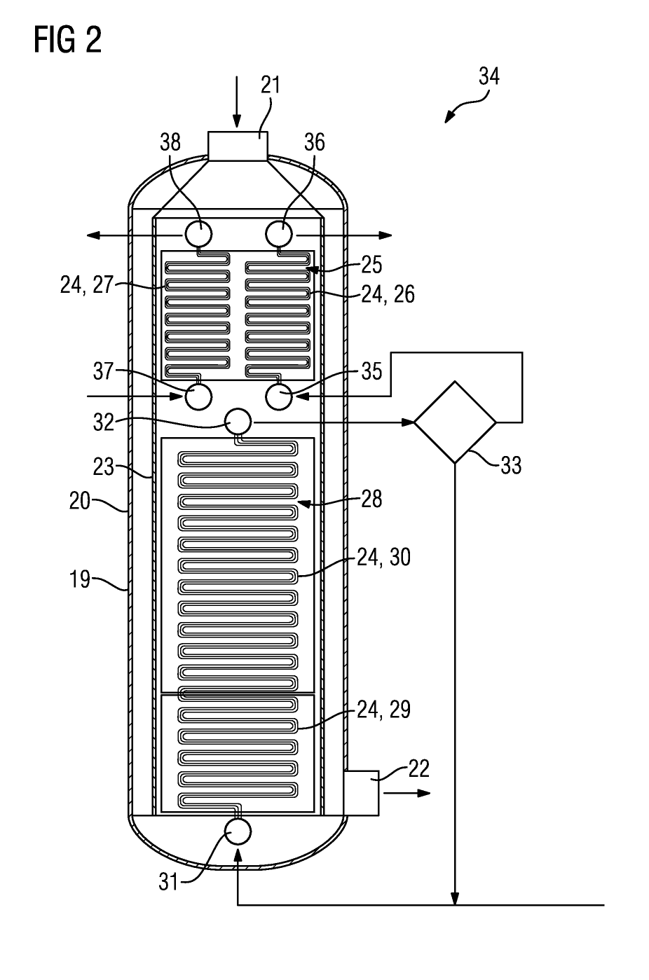

FIG. 2 shows an embodiment of the steam generator 19 according to the invention, in which all steam generator components referred to, i.e. preheater, evaporator, superheater and intermediate superheater, are combined in one component. The continuous-flow steam generator 19 comprises a pressure vessel 20, which has a heat transfer medium inlet 21 and a heat transfer medium outlet 22, between which a heat transfer medium passage 23 is formed. Steam generator tubes 24 are arranged in the heat transfer medium passage 23, wherein a first part 25 of the steam generator tubes 24 is designed as a system of superheater tubes 26 and intermediate superheater tubes 27 and a second part 28 of the steam generator tubes 24 is designed as a system of preheating tubes 29 and evaporator tubes 30.

During operation, a hot heat transfer medium, e.g. molten salt, is directed at the heat transfer medium inlet 21 into the pressure vessel 20 of the steam generator 19 and flows through the heat transfer medium passage 23 past the steam generator tubes 24 to the heat transfer medium outlet 22. Cold feed water is pumped via a feed water inlet 31 into the preheating tubes 29 and flows further through the evaporator tubes 30. The steam generated in the process is fed via a first steam outlet 32 to a water separation system 33 for separating water that has not evaporated. In this case, the steam generator 19 and the water separation system 33 form a steam generating arrangement 34. The remaining steam is fed again via a first steam inlet 35 to the steam generator 19 for superheating in the superheater tubes 26 and leaves the latter again via a second steam outlet 36 in the direction of the steam turbine 9. The steam partly expanded and cooled in the high-pressure part 10 of the steam turbine 9 is fed again to the steam generator 19 via a second steam inlet 37 for reheating and leaves the steam generator 19 again, after flowing through the intermediate superheater tubes 27, at the third steam outlet 38 in the direction of the intermediate-pressure part 11 of the steam turbine 9.

1-13. (canceled)

14. A continuous-flow steam generator, comprising:
a vessel which has a heat transfer medium inlet and a heat transfer medium outlet;
a heat transfer medium passage in which a heat transfer medium flows is formed between heat transfer medium inlet and heat transfer medium outlet; and
a plurality of steam generator tubes arranged in the heat transfer medium passage,
wherein a first part of the plurality of steam generator tubes is designed as a system of superheater tubes and intermediate superheater tubes,
wherein a second part of the steam generator tubes is designed as a system of preheating tubes and evaporator tubes, and
wherein the first part is arranged upstream of the second part in the direction of flow of the heat transfer medium.

15. The continuous-flow steam generator as claimed in claim 14, wherein superheater tubes and intermediate superheater tubes are connected up on a heat transfer medium side to form a heating surface.

16. The continuous-flow steam generator as claimed in claim 14, wherein the vessel is a pressure vessel.

17. The continuous-flow steam generator as claimed in claim 16, wherein the pressure vessel is designed in such a way that a heat transfer medium flows through the pressure vessel from top to bottom.

18. The continuous-flow steam generator as claimed in claim 17, wherein the heat transfer medium is molten salt.

19. The continuous-flow steam generator as claimed in claim 14, wherein the superheater tubes and the intermediate superheater tubes are arranged alternately side by side in the vessel in the direction of flow of the heat transfer medium.

20. The continuous-flow steam generator as claimed in claim 14, wherein the superheater tubes and the intermediate superheater tubes are arranged alternately one behind the other in the vessel in the direction of flow of the heat transfer medium.

21. A steam generating arrangement, comprising:
a continuous-flow steam generator as claimed in claim 14; and
a water separation system,
wherein the first part of the steam generator tubes is connected downstream of the water separation system on the flow medium side.

22. The steam generating arrangement as claimed in claim 21, wherein the second part of the steam generator tubes is connected upstream of the water separation system on the flow medium side.

23. The steam generating arrangement as claimed in claim 21, wherein superheater tubes adjoining evaporator tubes in parallel are connected directly downstream of the water separation system on the flow side.

24. A solar thermal power plant, comprising:
a steam generating arrangement as claimed in claim 21.

25. The solar thermal power plant as claimed in claim 24, further comprising a solar tower.

26. The solar thermal power plant as claimed in claim 24, further comprising parabolic trough collectors.

27. The solar thermal power plant as claimed in claim 24 further comprising Fresnel collectors.
